(19) United States
(12) Patent Application Publication
(10) Pub. No.: US 2005/0205521 A1
(43) Pub. Date: Sep. 22, 2005

(54) Wet etching apparatus and wet etching method

(75) Inventors: Satsohi Kume, Hyogo (JP); Hiroshi Sugahara, Hyogo (JP); Nobuyuki Hishinuma, Hyogo (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: Semiconductor Leading Edge Technologies, Inc., Tsukuba-shi (JP); Ushio Denki Kabushiki Kaisha, Tokyo-to (JP)

(21) Appl. No.: 11/038,191

(22) Filed: Jan. 21, 2005

(30) Foreign Application Priority Data
Mar. 17, 2004 (JP) 2004-075987

(51) Int. Cl. B44C 1/22

(52) U.S. Cl. 216/87; 216/88; 156/345.21

(57) ABSTRACT

A wet etching apparatus comprises a stage for fixing a substrate having a major surface covered with a film to be etched, a rotation mechanism for rotating the stage, a rotation controller for controlling rotation operation by the rotation mechanism, an ultraviolet irradiation unit having a light source for irradiating a portion of the major surface of the substrate with ultraviolet radiation, and an etching solution supply unit for supplying etching solution to the major surface of the substrate. The entire surface of the substrate can be irradiated with the ultraviolet radiation by a rotation of the stage.

### CROSS-REFERENCE TO RELATED APPLICATIONS

This Application is based upon and claims the benefit of priority from the prior Japanese Patent Application No. 2004-075987, filed on Mar. 17, 2004; the entire contents of which are incorporated herein by reference.

### BACKGROUND OF THE INVENTION

The invention relates to a wet etching apparatus and a wet etching method using the same, and more particularly, to a wet etching apparatus for reliably and easily etching material with high bonding energy such as HfO₂ (hafnium oxide) formed on a large-area substrate, and a wet etching method using the same.

As a gate oxide film for the next-generation ultrafine MOSFET, high-k film of hafnium oxide (HfO₂), for example, has drawn attention. However, hafnium oxide is hardly soluble material by nature, and in particular upon heat treatment (post deposition anneal), the film becomes extremely compact. For this reason, such thin film with stable composition having extremely high bonding energy is difficult to etch away.

Various methods of etching such material have been tried. In an effective method among others, at the time of wet etching, the thin film is irradiated across etching solution with ultraviolet light having energy greater than the bandgap. This is because bonds in the film are damaged by irradiation of ultraviolet light (UV light) and become susceptible to reaction with the etching solution. One of the most convenient methods is to coat hafnium oxide (HfO₂) thin film formed on a silicon substrate with etching solution, followed by irradiation of the entire substrate surface with an ultraviolet lamp placed in close proximity.

As another apparatus for performing a process in parallel with ultraviolet irradiation, although the object irradiated with ultraviolet light is different, an apparatus is proposed that varies oxidizing or reducing power and hydrophilicity by irradiating CMP slurry with ultraviolet light to enhance polishing rate and precision (see Japanese Laid-Open Patent Application 2000-113370).

However, such technologies for performing a process while irradiating the entire substrate surface with ultraviolet light have the following problems.

As a wafer to be etched grows in size, a larger space is needed to install a box-like casing called ♭lamp house”, which encloses an ultraviolet lamp and is filled with nitrogen gas around the lamp. As a result, the entire etching apparatus becomes large. Power consumption also increases accordingly.

Furthermore, in etching process, the spacing between the thin film on the silicon substrate coated with etching solution and the ultraviolet lamp is as small as about 2 to 10 mm. Once the process is started and the ultraviolet lamp is brought close to the entire substrate surface, it is difficult to additionally supply etching solution onto the thin film during irradiation of ultraviolet light. For this reason, etching may stop halfway when the etching rate is determined by the supply rate of etching solution, that is, when the supply of etchant (etching species) is a rate-limiting factor.

As another problem, when a silicon substrate at rest is coated with etching solution and irradiated with ultraviolet radiation, etched residuals eluted into the etching solution are not efficiently removed away from the silicon substrate, and may be adhered again to the surface of the substrate.

As described above, the technologies for performing wet etching in parallel with ultraviolet irradiation have some problems, which prevent their practical use.

### SUMMARY OF THE INVENTION

According to an aspect of the invention, there is provided a wet etching apparatus comprising: a stage for fixing a substrate having a major surface covered with a film to be etched; a rotation mechanism for rotating the stage; a rotation controller for controlling rotation operation by the rotation mechanism; an ultraviolet irradiation unit having a light source for irradiating a portion of the major surface of the substrate with ultraviolet radiation; and an etching solution supply unit for supplying etching solution to the major surface of the substrate, wherein the entire surface of the substrate can be irradiated with the ultraviolet radiation by a rotation of the stage.

The ultraviolet irradiation unit may be connected to an ultraviolet irradiation control mechanism, and the ultraviolet irradiation control mechanism may fix the light source at a position of 2 to 10 millimeters above the substrate during an etching process by controlling a up-and-down driver.

The ultraviolet irradiation unit may be provided with an irradiation window that transmits the ultraviolet radiation emitted from the light source, the irradiation window facing the major surface of the substrate and covering at least the radius of the substrate.

The area of the irradiation window that faces the substrate may be at least ¼ or more of the area of the substrate.

The etching solution supply unit may be connected to an etching solution supply controller, and the etching solution supply controller can supply etching solution during an etching process.

The rotation controller may rotate the stage at a rotation speed of 50 revolutions per minute or more.

The substrate stage may have a flat support surface, and the substrate may be supported in close contact with the support surface.

The substrate stage may have suction means for sucking the substrate to the support surface.

The ultraviolet irradiation control mechanism may be able to move the ultraviolet irradiation unit away from over the substrate stage.

The ultraviolet irradiation unit may be provided with an irradiation window that emits the ultraviolet radiation emitted from the light source, the irradiation window facing the major surface of the substrate, the apparatus further comprising: cleaning means for cleaning the irradiation window when the ultraviolet irradiation unit is moved away from over the substrate stage.

According to an aspect of the invention, there is provided a wet etching method comprising: rotating a substrate, with a portion of a film to be etched formed on the substrate being irradiated with ultraviolet radiation across etching solution supplied onto the film to be etched.

The substrate may be rotated, with a light source that emits the ultraviolet radiation being held at a position of 2 to 10 millimeters above the substrate.

The ultraviolet radiation may be emitted, with an irradiation window that covers at least the radius of the substrate being interposed between the light source that emits the ultraviolet radiation and the substrate.

The area of the irradiation window that faces the substrate may be at least ¼ or more of the area of the substrate.

The etching solution may be supplied during rotation of the substrate.

The substrate may be rotated at a rotation speed of 50 revolutions per minute or more.

The substrate may be rotated in close contact with a flat support surface.

The substrate may be rotated with being sucked to the support surface.

An irradiation unit for the ultraviolet radiation may be able to be moved away from over the substrate.

The irradiation window for the ultraviolet radiation may be cleaned when the irradiation unit for the ultraviolet radiation is moved away from over the substrate.

### BRIEF DESCRIPTION OF THE DRAWINGS

The present invention will be understood more fully from the detailed description given herebelow and from the accompanying drawings of the embodiments of the invention. However, the drawings are not intended to imply limitation of the invention to a specific embodiment, but are for explanation and understanding only.

In the drawings:

FIG. 1 is a schematic view showing the structure of a wet etching apparatus according to an embodiment of the invention;

FIG. 2A is a side view of the wet etching apparatus shown in FIG. 1;

FIG. 2B is a cross-sectional view of the wet etching apparatus shown in FIG. 1;

FIGS. 3A and 3B are conceptual views showing how the etching process in an embodiment of the invention is performed;

FIG. 4 is a chart showing the dependence of etching rate on the substrate rotation speed;

FIG. 5A is a schematic cross-sectional view showing a variation of a wet etching apparatus according to the invention;

FIG. 5B is a schematic plan view showing a variation of a wet etching apparatus according to the invention; and

FIG. 6 is a schematic view showing another variation of a wet etching apparatus according to the invention.

### DETAILED DESCRIPTION

Embodiments of the invention will now be described with reference to the drawings.

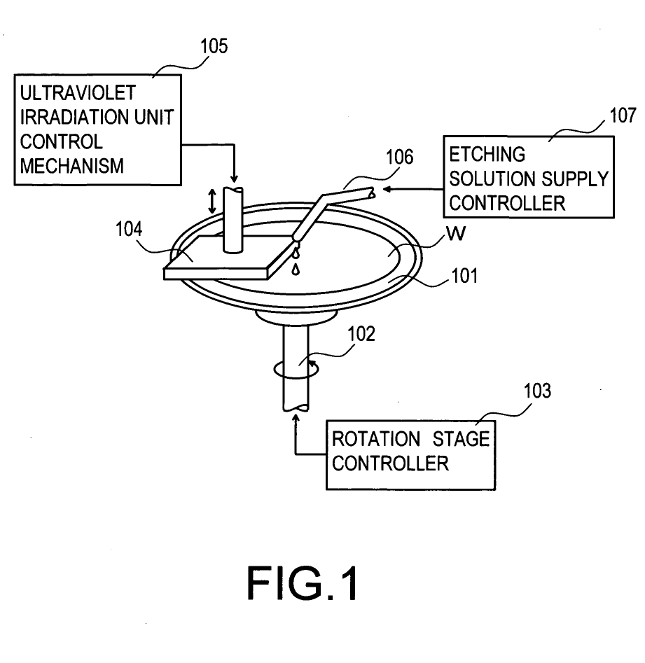

FIG. 1 is a schematic view showing the structure of a major part of a wet etching apparatus according to an embodiment of the invention.

A substrate W covered with film to be etched is fixed on a rotation stage 101. The rotation stage 101 is attached to a rotation shaft 102, and is under rotation control of a rotation stage controller 103.

An ultraviolet irradiation unit 104 is placed to cover part of the substrate W. An ultraviolet irradiation unit control mechanism 105 controls the adjustment of ultraviolet light and the movement of the irradiation unit. The ultraviolet irradiation unit 104 moves upward when the substrate W is attached to or detached from the rotation stage 101, and is lowered near the substrate W only during etching. The surface of the ultraviolet irradiation unit 104 that faces the substrate W is provided with an irradiation window, not shown, from which ultraviolet light is emitted.

An etching solution supply nozzle 106 is placed at a location where it does not interfere with the ultraviolet irradiation unit 104 because the etching solution supply nozzle 106 may function when the ultraviolet irradiation unit 104 is lowered near the substrate W. Supply of etching solution from the etching solution supply nozzle 106 is controlled by an etching solution supply controller 107.

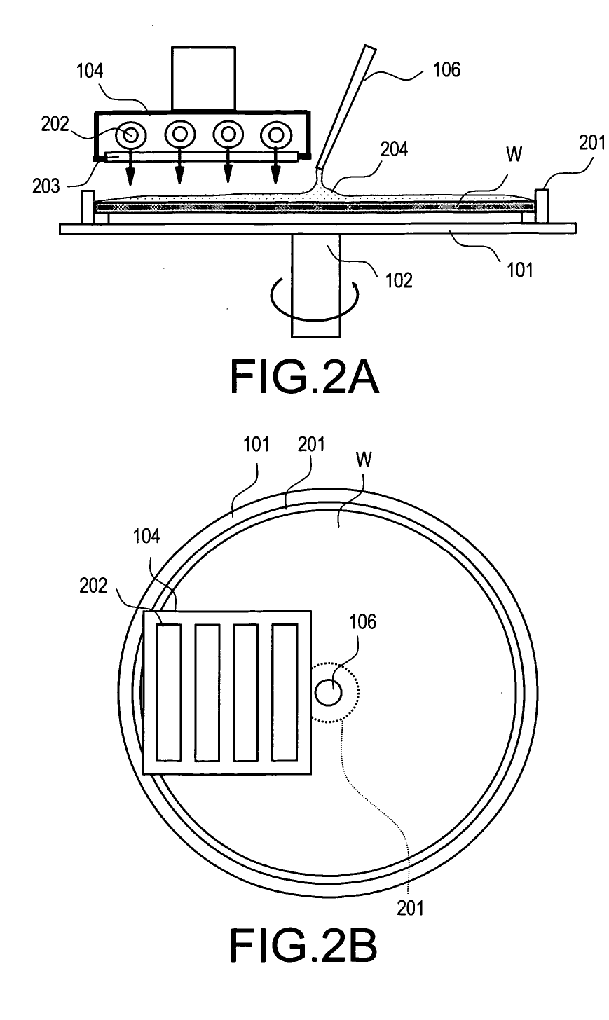

FIG. 2 shows a side view (FIG. 2A), and a cross-sectional view (FIG. 2B) of the wet etching apparatus shown in FIG. 1. The elements shown in FIG. 1 are marked with the same numerals.

The rotation stage 101 is provided with fixing pins 201 for fixing the substrate W to avoid its shift by rotating motion.

The ultraviolet irradiation unit 104 is provided with straight-type ultraviolet light lamps 202, which emit ultraviolet light via the irradiation window 203. It is sufficient that the irradiation window 203 covers the radius of the substrate W and accounts for at least ¼ of the area of the substrate W. As compared to the irradiation area covering the entire substrate surface, the power consumption is significantly smaller.

Etching solution 204 supplied from the etching solution supply nozzle 106 spreads over the film to be etched by centrifugal force due to rotation. In view of this effect, it is desirable that the etching solution supply nozzle 106 is placed as close to the center of the substrate W as possible. Etching residuals generated during the etching process can be removed by this centrifugal force. An etching solution recovery port shaped like a groove may be provided near the fixing pin 201 to recover used etching solution as appropriate.

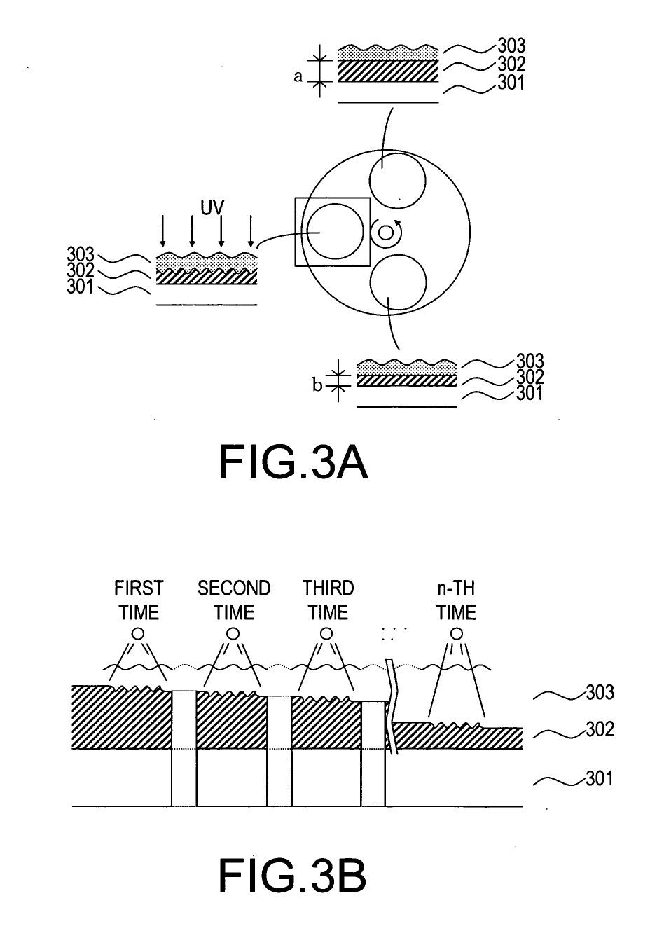

FIG. 3 is a conceptual view showing how the etching process in an embodiment of the invention is performed. Also here, the elements described above are marked with the same numerals and will not be described.

FIG. 3A is a conceptual view showing how the substrate W is rotated, and the cross-section of the substrate W before and after it is irradiated with ultraviolet light-under the ultraviolet irradiation unit 104.

Hafnium oxide (HfO₂) film 302 formed on a silicon substrate 301 is damaged in its bonds by ultraviolet light emitted from the ultraviolet irradiation unit 104 and becomes easy to dissolve into etching solution 303. Thus the etching process is activated. Before and after exposure to ultraviolet light, the thickness of the hafnium oxide (HfO₂) film changes from a to b (a>b), which indicates that the etching process is advanced.

FIG. 3B is a conceptual view showing the cross-section of the substrate W in the course of advancing the etching process with continuing rotation.

Etching for the hafnium oxide (HfO₂) film 302 is activated each time (for the first, second, . . . , n-th time) it passes under the ultraviolet irradiation unit 104 along with rotation of the substrate. Accordingly, the etching rate increases, and the total etching time is significantly reduced.

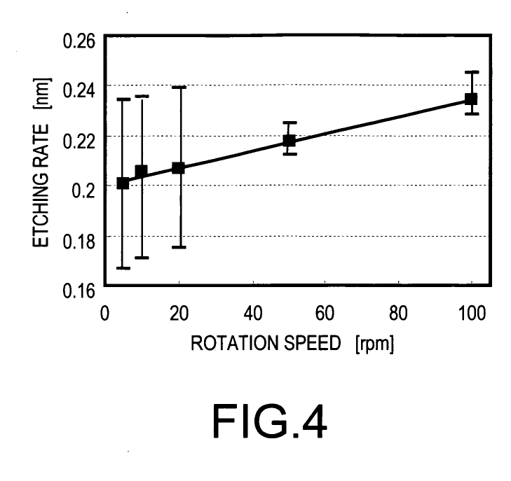

FIG. 4 is a chart showing the dependence of etching rate on the substrate rotation speed when wet etching is actually performed in parallel with ultraviolet irradiation. The vertical axis represents the etching rate (nanometers/min), and the horizontal axis represents the rotation speed (rpm) of the substrate.

Measurements were performed using as a sample a film of hafnium oxide (HfO₂) formed by ALD (Atomic Layer Deposition) followed by heat treatment in nitrogen (N₂) at 800° C, and using phosphoric acid based etching solution. The apparatus used was a single wafer spin cleaner equipped with an ultraviolet irradiator having a drive unit that can approach the vicinity of the substrate after the etching solution was dripped. The condition of ultraviolet irradiation was excimer light of 222 nanometers at 9 W/cm², and irradiation time fixed to 120 seconds. The area of the ultraviolet irradiation window was ¼ of that of the substrate, which can be irradiated uniformly on the entire surface by rotation of the substrate. A predetermined amount of etching solution was supplied in advance, and it was not newly supplied during irradiation.

The rotation speed of the substrate was changed from 5 to 100 rpm (revolutions/min), and it was found that the higher the rotation speed, the higher the etching rate despite that both the etching time and irradiation time were fixed. It was also observed that error bars were smaller and the in-plane uniformity was enhanced for the rotation speed of about 50 rpm or more. This suggests that because the ultraviolet irradiation window irradiated an area of only about ¼ of the substrate, the interval between presence and absence of irradiation of the film surface decreased and approximated to continuous irradiation as the rotation speed increased, which enhanced the effect on the Hf—O bond. It is also contemplated that for higher rotation speeds, etching solution coated on the film was thinly and uniformly spread, which contributed to the enhancement of transmissivity of ultraviolet light.

It was at 100 rpm (revolutions/min) that an etching rate comparable to that for continuous irradiation of the entire substrate surface was obtained. The rotation speed of 50 rpm (revolutions/min) is the minimum rotation speed at which enhancement of in-plane uniformity is observed.

As described above, in using the wet etching apparatus of the invention, while a substrate covered with film to be etched is rotated at a rotation speed of 50 rpm (revolutions/min) or more, wet etching is performed along with ultraviolet irradiation of an area of about ¼ of the substrate, thereby enhancing the etching rate. In particular, it is extremely effective for the etching of material that has high bonding energy and is difficult to etch such as hafnium oxide (HfO₂).

Furthermore, etching solution can be supplied in a region where the ultraviolet irradiation unit is not placed. As a result, etching solution can be additionally supplied during the etching process, and thus the etching process can be smoothly performed even when supply of etching species is a rate-limiting factor.

Furthermore, etching residuals generated during the etching process can be efficiently removed by centrifugal force of the substrate rotation.

In addition, the ultraviolet irradiation unit is reduced to a size comparable to ¼ of the area of the substrate. As a result, power consumption can be reduced, and the apparatus itself can also be downsized.

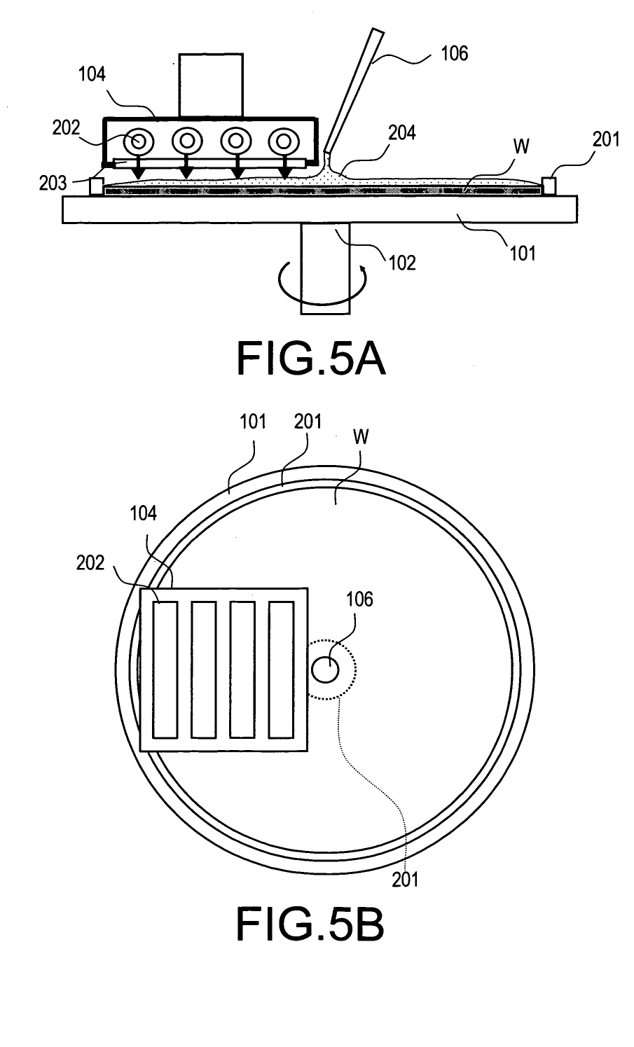

FIG. 5 is a schematic view showing a variation of a wet etching apparatus according to the invention. More specifically, FIG. 5A is its cross-sectional view, and FIG. 5B is its plan view.

In this variation, the rotation stage 101 is thickly formed and has a flat holding surface. The substrate W is sucked and fixed on the rotation stage 101.

The ultraviolet irradiation unit 104 is placed closer to the substrate W. That is, the distance between the irradiation unit 104 and the substrate W is reduced so that irradiation energy can be exerted more intensely.

To this end, however, the levelness of the substrate W must be maintained with accuracy during rotation of the substrate W. Since typical thickness of a silicon wafer used as the substrate W is about 0.7 mm, deflection may occur depending on the holding method for a diameter of 300 mm. The etching apparatus described above with reference to FIG. 1 is provided with a substrate stage for holding only the periphery of the substrate W. In contrast, in this variation, the substrate W is sucked and firmly fixed on a disc-shaped rotation stage 101 that can maintain the surface flatness. This eliminates flutter induced by rotation (primarily, a phenomenon in which the deflected portion of the substrate W flutters up and down by airflow), and thus the irradiation unit 104 can be brought closer to the substrate W with an ensured clearance. As a result, more intense irradiation energy can be exerted on the substrate W, thus enabling efficient wet etching.

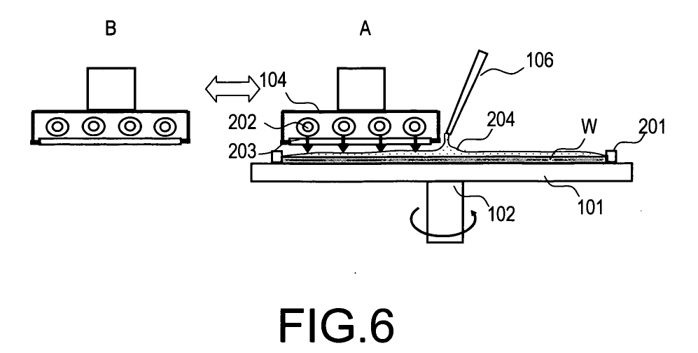

FIG. 6 is a schematic view showing another variation of a wet etching apparatus according to the invention. More specifically, in this variation, the irradiation unit 104 is allowed to move between position A and position B. When the temperature of drug solution is increased during wet etching, the irradiation window 203 of the irradiation unit 104 may be fogged with the generated vapor. If the etching process is continued with fog on the irradiation window 203, ultraviolet light is scattered and prevented from fully reaching the film surface on the substrate W. In this respect, in this variation, the irradiation unit 104 can be moved to position B to clean drug solution condensed on the irradiation window 203. For example, each time one substrate W is etched, the irradiation unit 104 can be moved to position B to clean vapor condensed on the irradiation window 203. Alternatively, the irradiation unit 104 may be moved to position B to clean vapor condensed on the irradiation window 203 after wet etching is performed for a predetermined duration or number of times.

In any of the specific examples described above, a sufficient amount of ultraviolet light energy must reach the film surface of the substrate W through drug solution used for the etching. That is, it is desirable to select drug solution used for the etching that has sufficiently low absorption at the wavelength of the ultraviolet light. In addition, it is desirable to optimize the properties of drug solution such as surface tension and viscosity so that the thickness of drug solution formed on the substrate W during rotation does not exceed the thickness at which the ultraviolet light is screened. For example, it is desirable to keep the thickness of the drug solution layer formed on the surface of the substrate W at 1 mm or less during rotation at a rotation speed of 500 rpm or less.

It is also important to select drug solution so that it is not repelled or dried in the process of being spread on the surface of the substrate W by the rotation of the substrate W. In addition, it is also necessary to select drug solution that is free from white turbidity and crystal precipitation.

On the other hand, with respect to the wavelength of ultraviolet radiation, wavelengths that are not absorbed by oxygen in the air are desirable. The best wavelength that is less prone to being absorbed by oxygen above the Hf—O bonding energy is 222 nm. At wavelengths above this, the energy may be insufficient. On the contrary, the ultraviolet radiation with a wavelength of 172 nm, which is commonly used as ultraviolet radiation in a wavelength range of 222 nm or less, has sufficiently high energy but is absorbed by oxygen. For this reason, the atmosphere around the etching process unit must be replaced by nitrogen to reduce the oxygen concentration to the minimum.

With respect to material to be etched, HfO₂, which has been presented as a specific example, is one of the materials that are very difficult to etch. The invention can be applied to any etching process that uses ultraviolet radiation having higher irradiation energy than the bonding energy of the film to be etched. The object to be etched may also include, for example, resist film, and modified resist film damaged by plasma. When they are etched, ozone water is irradiated with ultraviolet light, and then radicals and the like generated by decomposition are caused to act as etching species. That is, energy emitted from the ultraviolet irradiation unit 104 is used to decompose ozone water into radicals and the like, and thereby etching can be performed. In this case, the ozone water may preferably be uniformly distributed over the surface of the substrate in order to perform a uniform etching.

While the present invention has been disclosed in terms of the embodiment in order to facilitate better understanding thereof, it should be appreciated that the invention can be embodied in various ways without departing from the principle of the invention. Therefore, the invention should be understood to include all possible embodiments and modification to the shown embodiments which can be embodied without departing from the principle of the invention as set forth in the appended claims.

1. A wet etching apparatus comprising:
a stage for fixing a substrate having a major surface covered with a film to be etched;
a rotation mechanism for rotating the stage;
a rotation controller for controlling rotation operation by the rotation mechanism;
an ultraviolet irradiation unit having a light source for irradiating a portion of the major surface of the substrate with ultraviolet radiation; and
an etching solution supply unit for supplying etching solution to the major surface of the substrate, wherein the entire surface of the substrate can be irradiated with the ultraviolet radiation by a rotation of the stage.

2. The wet etching apparatus as claimed in claim 1, wherein the ultraviolet irradiation unit is connected to an ultraviolet irradiation control mechanism, and the ultraviolet irradiation control mechanism fixes the light source at a position of 2 to 10 millimeters above the substrate during an etching process.

3. The wet etching apparatus as claimed in claim 1, wherein the ultraviolet irradiation unit is provided with an irradiation window that transmits the ultraviolet radiation emitted from the light source, the irradiation window facing the major surface of the substrate and covering at least the radius of the substrate.

4. The wet etching apparatus as claimed in claim 3, wherein the area of the irradiation window that faces the substrate is at least ¼ or more of the area of the substrate.

5. The wet etching apparatus as claimed in claim 1, wherein the etching solution supply unit is connected to an etching solution supply controller, and the etching solution supply controller can supply etching solution during an etching process.

6. The wet etching apparatus as claimed in claim 1, wherein the rotation controller rotates the stage at a rotation speed of 50 revolutions per minute or more.

7. The wet etching apparatus as claimed in claim 1, wherein the substrate stage has a flat support surface, and the substrate is supported in close contact with the support surface.

8. The wet etching apparatus as claimed in claim 7, wherein the substrate stage has suction means for sucking the substrate to the support surface.

9. The wet etching apparatus as claimed in claim 2, wherein the ultraviolet irradiation control mechanism can move the ultraviolet irradiation unit away from over the substrate stage.

10. The wet etching apparatus as claimed in claim 9, wherein the ultraviolet irradiation unit is provided with an irradiation window that emits the ultraviolet radiation emitted from the light source, the irradiation window facing the major surface of the substrate, the apparatus further comprising:
cleaning means for cleaning the irradiation window when the ultraviolet irradiation unit is moved away from over the substrate stage.

11. A wet etching method comprising:
rotating a substrate, with a portion of a film to be etched formed on the substrate being irradiated with ultraviolet radiation across etching solution supplied onto the film to be etched.

12. The wet etching method as claimed in claim 11, wherein the substrate is rotated, with a light source that emits the ultraviolet radiation being held at a position of 2 to 10 millimeters above the substrate.

13. The wet etching method as claimed in claim 11, wherein the ultraviolet radiation is emitted, with an irradiation window that covers at least the radius of the substrate being interposed between the light source that emits the ultraviolet radiation and the substrate.

14. The wet etching method as claimed in claim 13, wherein the area of the irradiation window that faces the substrate is at least ¼ or more of the area of the substrate.

15. The wet etching method as claimed in claim 11, wherein etching solution is supplied during rotation of the substrate.

16. The wet etching method as claimed in claim 11, wherein the substrate is rotated at a rotation speed of 50 revolutions per minute or more.

17. The wet etching method as claimed in claim 11, wherein the substrate is rotated in close contact with a flat support surface.

18. The wet etching method as claimed in claim 17, wherein the substrate is rotated with being sucked to the support surface.

19. The wet etching method as claimed in claim 11, wherein an irradiation unit for the ultraviolet radiation can be moved away from over the substrate.

20. The wet etching method as claimed in claim 19, wherein the irradiation window for the ultraviolet radiation is cleaned when the irradiation unit for the ultraviolet radiation is moved away from over the substrate.
